(19) United States
(12) Patent Application Publication
(10) Pub. No.: US 2004/0028202 A1
(43) Pub. Date: Feb. 12, 2004

(54) Method and system for providing conference feature between internet call and telephone network call in a webphone system

(76) Inventors: Jung-Ouk Lim, Suwon-shi (KR); Jong-Won Kim, Seoul (KR)

Correspondence Address: Robert E. Bushnell, Suite 300, 1522 K Street, N.W., Washington, DC, 20005, US

(21) Appl. No.: 10/214,093

(22) Filed: Aug. 8, 2002

(51) Int. Cl. H04M 3/42

(52) U.S. Cl. 379/202.01; 379/219

(57) ABSTRACT

A method for performing a conference call between an Internet call and a telephone network call in a webphone system includes receiving a conference call key input in a point-to-point call state; checking whether there exists a held call in response to the conference call key input; adding a speech channel and forming a forming a speech path between subscribers, when there exists a held call; and performing a conference call when the speech path is formed.

### BACKGROUND OF THE INVENTION

1. Field of the Invention

The present invention relates generally to a conference call in a webphone system, and in particular, to a method and system for providing conference feature between an Internet call and a telephone network call in a webphone system, wherein the Internet call is connected to the telephone network call through switching to enable a conference call between subscribers to the Internet and subscribers to the telephone network.

2. Description of the Related Art

Generally, a communication system provides various services such as a conference call or multiparty (or point-to-multipoint) call service using a keyphone or a private branch exchange (PBX). In particular, U.S. Pat. No. 6,072,780 by Johnson, Jr. et al. for Dial up Telephone Conference System Controlled by an Online Computer Network discloses telephone conference between office line subscribers through the Internet. The telephone conference is held through digital control on a telephone network and a gateway. Further, a webphone equipped with a speaker and a microphone accesses a host which provides a webphone service using a computer with communication equipment capable of accessing the Internet, and downloads directory information, i.e., origination/destination access information for connecting the origination (calling party) and the destination (called party), to make an Internet call to a desired destination. However, calling subscribers to the telephone network and the Internet is performed through network control by the computer. Thus, there is a need for a webphone capable of supporting a conference call by itself.

### SUMMARY OF THE INVENTION

It is, therefore, an object of the present invention to provide a method for providing a conference call between subscribers to the Internet and subscribers to a telephone network such as PSTN (Public Switched Telephone Network) and ISDN (Integrated Services Digital Network) in a webphone.

It is another object to provide a webphone that enables a conference call among multiple subscribers to the telephone network and the Internet, so the user is not required to inconveniently reconnect a call to the telephone network in order to make a conference call with a subscriber to the telephone network during an Internet call.

It is yet another object to provide a webphone that enables a conference call and is easy and inexpensive to use.

To achieve the above and other objects, there is provided a method for providing a conference call between Internet subscribers and telephone network subscribers. The method comprises the steps of: holding a current state by a user when an origination or termination call is initiated; calling another subscriber and forming a new speech path; if the held call selects a telephone network, connecting the call again in an Internet call mode, and if the held call selects the Internet, connecting the call again in a telephone network mode; and if the user selects a conference call mode after forming the speech path, performing a conference call.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a schematic block diagram of a webphone system to which the present invention is applied;

FIG. 2 illustrates a detailed structure of the webphone system of FIG. 1;

FIG. 3 illustrates a procedure for providing conference feature between an Internet call and a telephone network call according to an embodiment of the present invention;

FIG. 4 illustrates a procedure for receiving a new incoming call during a conference call according to an embodiment of the present invention;

FIG. 5 illustrates a procedure for holding a call during the conference call according to an embodiment of the present invention;

FIG. 6 illustrates a procedure for reconnecting the held conference call in a point-to-point call state according to an embodiment of the present invention; and

FIG. 7 illustrates a procedure for reconnecting the held conference call in an idle state according to an embodiment of the present invention.

### DETAILED DESCRIPTION OF THE PREFERRED EMBODIMENTS

This application makes reference to, incorporates the same herein, from my application entitled METHOD AND SYSTEM FOR PROVIDING CONFERENCE FEATURE BETWEEN INTERNET CALL AND TELEPHONE NETWORK CALL IN A WEBPHONE SYSTEM filed with the Korean Industrial Property Office on Feb. 21, 2001 and there duly assigned Serial No. 2001-8790.

A preferred embodiment of the present invention will be described herein below with reference to the accompanying drawings. In the following description, well-known functions or constructions are not described in detail since they would obscure the invention in unnecessary detail.

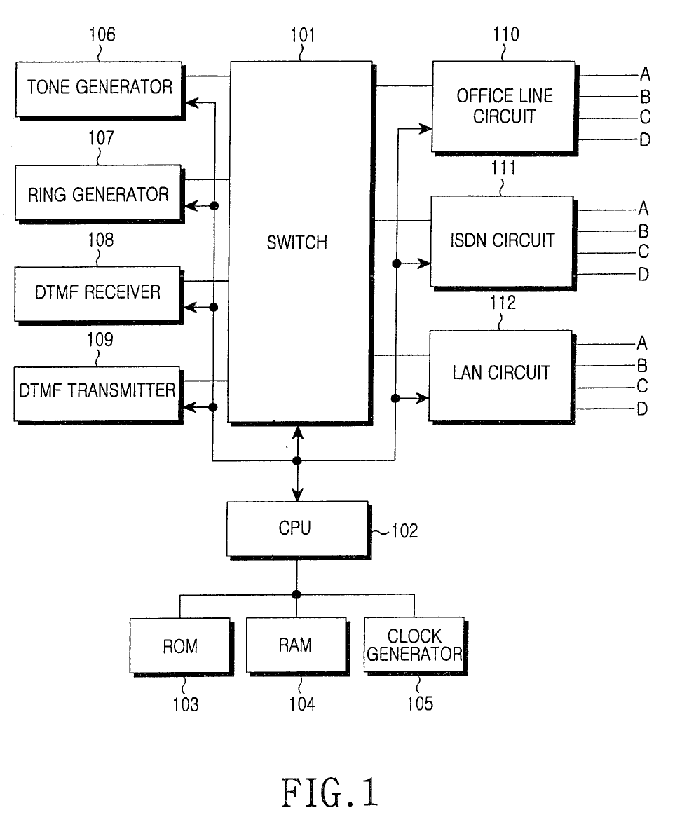

FIG. 1 illustrates a schematic block diagram of a webphone system to which the present invention is applied. Referring to FIG. 1, the webphone system includes an office line circuit 110 connected to PSTN (Public Switched Telephone Network), an ISDN (Integrated Services Digital Network) circuit 111 also connected to the ISDN, a LAN (Local Area Network) circuit 112 connected to the Internet, a tone generator 106 for generating a tone signal, a ring generator 107 for generating a ring signal, a DTMF (Dual Tone Multi-Frequency) receiver 108 for receiving a DTMF signal, a DTMF transmitter 109 for transmitting a DTMF signal, a ROM (Read Only Memory) 103, a RAM (Random Access Memory) 104, a CPU (Central Processing Unit) 102 for controlling a conference call according to the present invention, and a switch 101 for enabling the conference call between the telephone network through the office line circuit 110 and the ISDN circuit 111 and the Internet through the LAN circuit 112. The switch 101 is realized by software to enable the conference call through the CPU 102, the office line circuit 110, the ISDN circuit 111 and the LAN circuit 112.

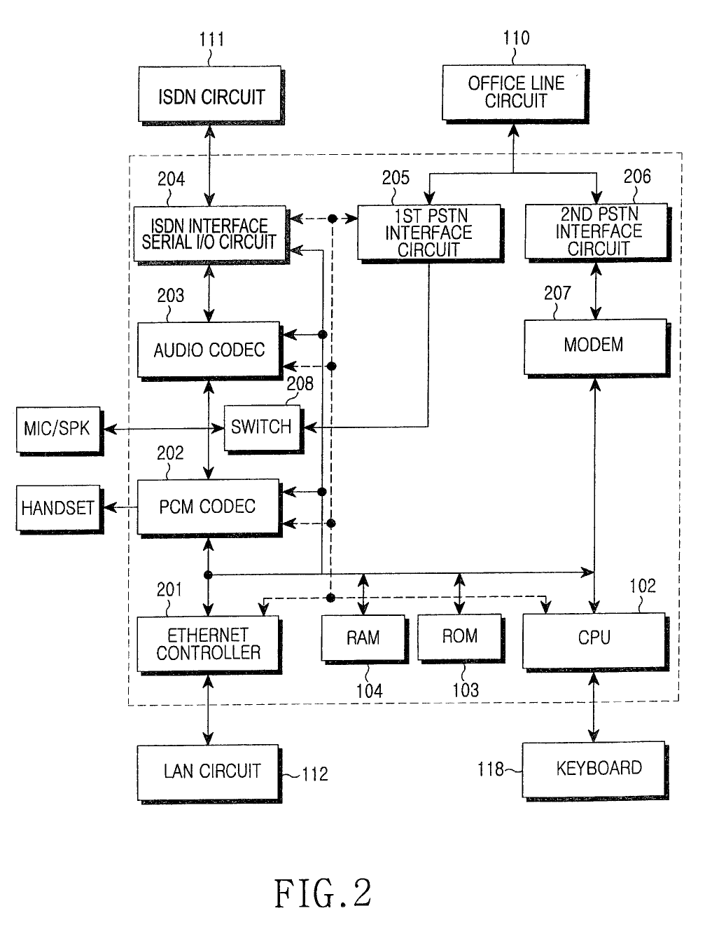

FIG. 2 illustrates a detailed structure of the webphone system of FIG. 1. Referring to FIG. 2, the webphone system includes an Ethernet controller 201 connected to the LAN circuit 112, an ISDN interface serial input/output circuit 204 connected to the ISDN circuit 111, a first PSTN interface circuit 205 connected to the office line circuit 110, a second PSTN interface circuit 206 also connected to the office line circuit 110, an audio codec 203 for coding/decoding data input from and output to the ISDN interface serial input/output circuit 204 into audio data and audio signal, a PCM (Pulse Code Modulation) codec 202 for coding/decoding signals received from the audio codec 203 and the Ethernet controller 201 into PCM data and providing the PCM data to a handset, and the CPU 102 for enabling the conference call using the webphone by controlling the first PSTN interface circuit 205, the second PSTN interface circuit 206, the ISDN interface serial input/output circuit 204 and the Ethernet controller 201 based on data stored in the ROM 104 and the RAM 103. Further, the webphone system includes a switch 208 for switching the first PSTN interface circuit 205, the microphone (MIC) and the speaker (SPK), and a modem 207 for processing data in cooperation with the second PSTN interface circuit 206.

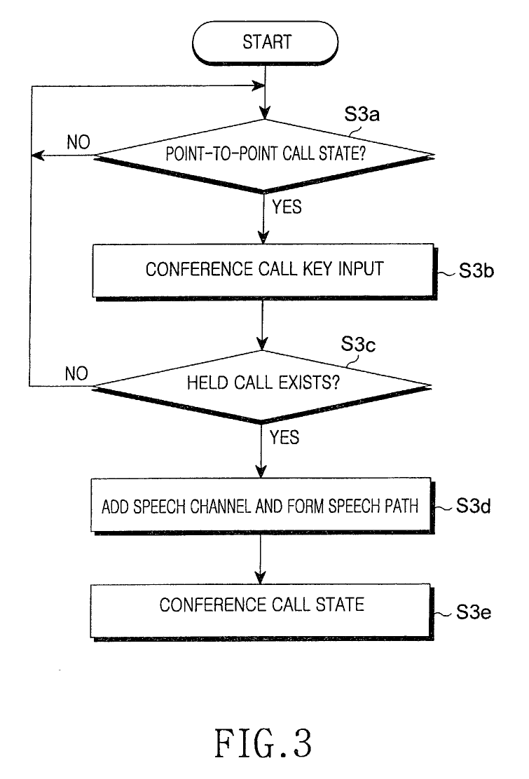

FIG. 3 illustrates a procedure for providing conference feature between an Internet call and a telephone network call according to an embodiment of the present invention. Referring to FIG. 3, the procedure includes the steps of (S3a) receiving a conference call key input in a single-call (or point-to-point call) state, (S3b and S3c) checking whether there exists a held call in response to the conference call key input, (S3d) adding a speech channel and forming a speech path between subscribers, when there exists a held call, and (S3e) performing a conference call when the speech path is formed.

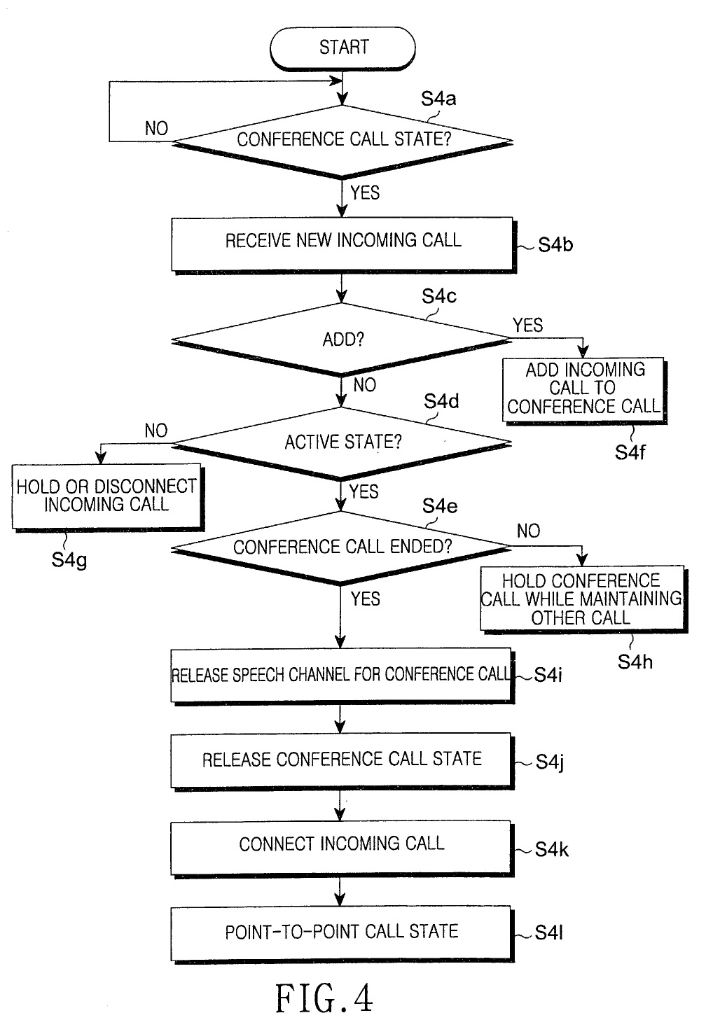

FIG. 4 illustrates a procedure for receiving a new incoming call during a conference call according to an embodiment of the present invention. Referring to FIG. 4, the procedure includes the steps of (S4a, S4b, S4c) checking whether to add a new incoming call to the conference call in a conference call state, (S4f) adding the incoming call to the conference call, when determining to add the incoming call to the conference call, (S4d) when determining not to add the incoming call to the conference call, checking whether the new incoming call is in an active state (or a busy state), and (S4g) holding or disconnecting the incoming call when the new incoming call is not in the active state, (S4e) checking whether the conference call is ended if the new incoming call is not in an active state, and (S4h) holding the conference call if the conference call is not ended, (S4i) releasing the speech channel over which the conference call is performed, if the conference call is ended, and (S4j) releasing the conference call state, and (S4k) then connecting the incoming call to enter a point-to-point call state (S4l).

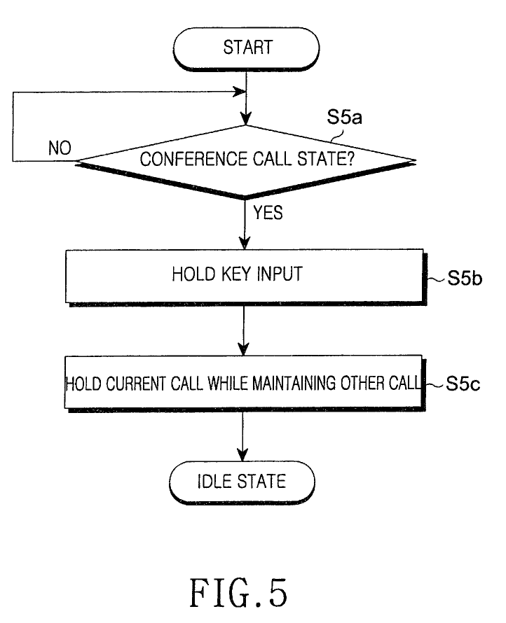

FIG. 5 illustrates a procedure for holding a call during the conference call according to an embodiment of the present invention. Referring to FIG. 5, the procedure includes the steps of (S5a) receiving a hold key input in the conference call state, and (S5b-S5c) holding a current call in response to the hold key input to enter an idle state.

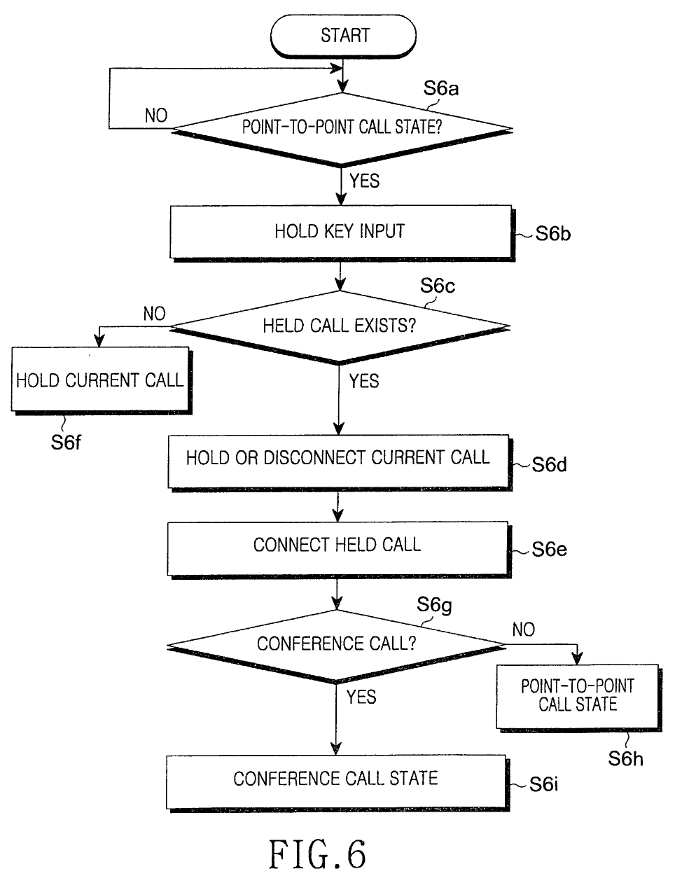

FIG. 6 illustrates a procedure for reconnecting the held conference call in a point-to-point call state according to an embodiment of the present invention. Referring to FIG. 6, the procedure includes the steps of (S6a-S5b) receiving a hold key input in the point-to-point call state, (S5c) checking whether there exists a held call in response to the hold key input, and holding a current call if there exists a held call, (S6f) holding the current call, if there exists no held call, and (S6d) holding or disconnecting the current call if there exists a held call, and (S6e) then connecting the held call, and (S6g) checking whether there exists a conference call, when the held call is connected, entering the point-to-point call state if there exists no conference call (S6h), and entering the conference call state if there exists a conference call (S6i).

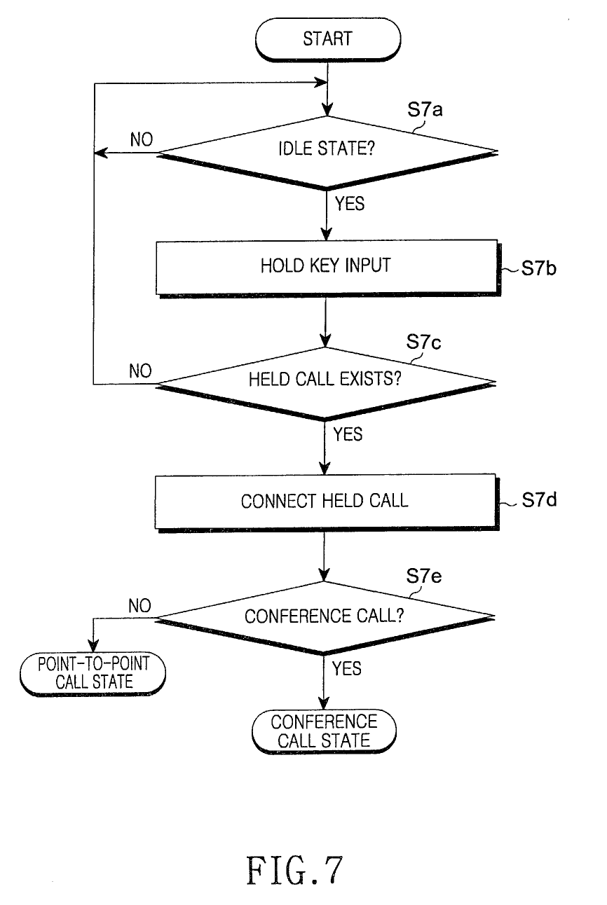

FIG. 7 illustrates a procedure for reconnecting the held conference call in an idle state according to an embodiment of the present invention. Referring to FIG. 7, the procedure includes the steps of (S7a) checking whether the current state is an idle state, (S7b) receiving a hold key input if the current state is an idle state, and (S7c) checking whether there exists a held call, (S7d) connecting the held call if there exists a held call, and (S7e) checking whether there exists a conference call, entering the point-to-point call state if there exists no conference call, and entering the conference call state if there exists a conference call.

A detailed description of the present invention will be made with reference to FIGS. 1 to 7. The present invention enables the webphone of FIG. 2 to provide conference feature between an incoming call from the telephone network such as the ISDN and PSTN and an incoming call from the Internet through for example the LAN. Here, the telephone ports are extendable by hardware.

Referring to FIG. 3, a description will be made of a procedure for entering a conference call state in response to a conference call key input by the user through a keyboard 118 when there exists another call held in an active state. In step S3a, the CPU 102 checks whether the current state is a point-to-point call state where, for example, a call is made between a subscriber to the ISDN and a subscriber to the PSTN on a one-to-one basis. If the current state is the point-to-point call state, the CPU 102 receives a conference call key input by the user through the keyboard 118 in step S3b. At the moment, if the current call is held through the first PSTN interface circuit 205 and the ISDN interface serial input/output circuit 204, the CPU 102 checks in step S3c whether there exists a held call. If there does not exist a held call, the CPU 102 returns to step S3a. Otherwise, if there exists a held call, the CPU 102 adds in step S3d a speech channel by controlling the first PSTN interface circuit 205 and the ISDN interface serial input/output circuit 204, and forms a speech path for a conference call among multiple subscribers through the LAN circuit 112 by controlling the Ethernet controller 201. Thereafter, the CPU 102 performs the conference call in step S3e.

Referring to FIG. 4, the CPU 102 checks in step S4a whether the current state is a conference call state in which a conference call is made through the Internet connected to the LAN circuit 112 by controlling the first PSTN interface circuit 205, the ISDN interface serial input/output circuit 204 and the Ethernet controller 201 in forming the speech path for the conference call in step 3e. If the current state is the conference call state, the CPU 102 receives a new incoming (terminated) call in step S4b. The CPU 102 determines in step S4c whether to add the new incoming call to the conference call. If the CPU 102 determines to add the new incoming call to the conference call, it connects the incoming call to the conference call in step S4f. However, if the CPU 102 determines not to add the new incoming call to the conference call, the CPU determines in step S4d whether the new call is in an active state. If the new call is not in the active state, the CPU 102 holds or disconnects the incoming call in step S4g. Otherwise, if the new call is in the active state, the CPU 102 determines in step S4e whether the conference call is ended. If the conference call is not ended, the CPU 102 holds the conference call while maintaining the other call, in step S4h. However, if the conference call is ended, the CPU 102 releases the speech channel used for the conference call in step S4i, and releases the conference call state in step S4j. Thereafter, the CPU 102 connects the incoming call in step S4k, and enters a point-to-point call state in step S4l.

Referring to FIG. 5, the CPU 102 determines in step S5a whether the current state is the conference call state. If the current state is the conference call state, the CPU 102 receives a hold key input by the user through the keyboard 118 in step S5b. Thereafter, in step S5c, the CPU 102 holds the current call with the Internet through the LAN circuit 112 by controlling the first PSTN interface circuit 205, the ISDN interface serial input/output circuit 204 and the Ethernet controller 201 while maintaining the other call. Subsequently, the CPU 102 enters an idle state.

Referring to FIG. 6, the CPU 102 checks in step S6a whether the current state is a point-to-point call state. If the current call state is the point-to-point call state, the CPU 102 receives a hold key input in step S6b. The CPU 102 checks in step S6c whether there exists a held call. If there exists no held call, the CPU 102 holds the current call in step S6f. Otherwise, if there exists a held call, the CPU 102 holds or disconnects the current call in step S6d, and connects the held call in step S6e. Subsequently, the CPU 102 determines in step S6g whether the call is a conference call. If the call is a conference call, the CPU 102 enters the conference call state in step S6i. Otherwise, if the call is not a conference call, the CPU 102 enters the point-to-point call state in step S6h.

Referring to FIG. 7, the CPU 102 checks in step S7a whether the current state is an idle state. If the current state is an idle state, the CPU 102 receives a hold key input in step S7b. The CPU 102 determines in step S7c whether there exists a held call. If there exists a held call, the CPU 102 connects a speech path with the Internet through the LAN circuit 112 in step S7d by controlling the first PSTN interface circuit 205, the ISDN interface serial input/output circuit 204 and the Ethernet controller 201. The CPU 102 determines in step S7e whether there exists a conference call. If there exists no conference call, the CPU 102 enters the point-to-point call state. Otherwise, if there exists a conference call, the CPU 102 enters the conference call state.

As described above, the webphone according to the present invention enables a conference call among multiple subscribers to the telephone network and the Internet, so the user is not required to inconveniently reconnect a call to the telephone network in order to make a conference call with a subscriber to the telephone network during an Internet call. In addition, since the conference call is made between a free Internet call and a telephone call, a telephone charge can be reduced.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for performing a conference call between an Internet call and a telephone network call in a webphone system, comprising the steps of:
receiving a conference call key input in a point-to-point call state;
checking whether there exists a held call in response to the conference call key input;
adding a speech channel and forming a speech path between subscribers, when there exists a held call; and
performing a conference call when the speech path is formed.

2. The method of claim 1, further comprising the steps of:
checking whether to add a new incoming call to the conference call in a conference call state;
adding the incoming call to the conference call, when determining to add the incoming call to the conference call;
when determining not to add the incoming call to the conference call, checking whether the new incoming call is in an active state, and holding or disconnecting the incoming call when the new incoming call is not in the active state;
checking whether the conference call is ended when the new incoming call is not in an active state, and holding the conference call when the conference call is not ended;
releasing the speech channel over which the conference call is performed, when the conference call is ended; and
releasing the conference call state, and then connecting the incoming call to enter a point-to-point call state.

3. The method of claim 2, further comprising the steps of:
receiving a hold key input in the conference call state; and
holding a current call in response to the hold key input to enter an idle state.

4. The method of claim 2, further comprising the steps of:
receiving a hold key input in the point-to-point call state;
checking whether there exists a held call in response to the hold key input, and holding a current call when there exists a held call;
holding the current call, when there exists no held call, and holding or disconnecting the current call when there exists a held call, and then connecting the held call; and
checking whether there exists a conference call, when the held call is connected, entering the point-to-point call state when there exists no conference call, and entering the conference call state when there exists a conference call.

5. The method of claim 3, further comprising the steps of:
checking whether the current state is an idle state, receiving a hold key input when the current state is an idle state, and checking whether there exists a held call;
connecting the held call when there exists a held call; and
checking whether there exists a conference call, entering the point-to-point call state when there exists no conference call, and entering the conference call state when there exists a conference call.

6. The method of claim 1, further comprising the steps of:
receiving a hold key input in the conference call state; and
holding a current call in response to the hold key input to enter an idle state.

7. The method of claim 1, further comprising the steps of:
receiving a hold key input in the point-to-point call state;
checking whether there exists a held call in response to the hold key input, and holding a current call when there exists a held call;
holding the current call, when there exists no held call, and holding or disconnecting the current call when there exists a held call, and then connecting the held call; and
checking whether there exists a conference call, when the held call is connected, entering the point-to-point call state when there exists no conference call, and entering the conference call state when there exists a conference call.

8. The method of claim 1, further comprising the steps of:
checking whether the current state is an idle state, receiving a hold key input when the current state is an idle state, and checking whether there exists a held call;
connecting the held call when there exists a held call; and
checking whether there exists a conference call, entering the point-to-point call state when there exists no conference call, and entering the conference call state when there exists a conference call.

9. The method of claim 5, further comprising the steps of:
receiving a hold key input in the point-to-point call state;
checking whether there exists a held call in response to the hold key input, and holding a current call when there exists a held call;
holding the current call, when there exists no held call, and holding or disconnecting the current call when there exists a held call, and then connecting the held call; and
checking whether there exists a conference call, when the held call is connected, entering the point-to-point call state when there exists no conference call, and entering the conference call state when there exists a conference call.

10. The method of claim 4, further comprising the steps of:
receiving a hold key input in the conference call state; and
holding a current call in response to the hold key input to enter an idle state.

11. The method of claim 7, further comprising the steps of:
checking whether the current state is an idle state, receiving a hold key input when the current state is an idle state, and checking whether there exists a held call;
connecting the held call when there exists a held call; and
checking whether there exists a conference call, entering the point-to-point call state when there exists no conference call, and entering the conference call state when there exists a conference call.

12. A system for providing conference feature between an Internet call and a telephone network call in a webphone system, comprising:
the system for supporting both the telephone network call and the Internet call, holding the telephone network call or the Internet call, connecting a speech path using an Internet line in a hold state so that an office line call can be connected in a Internet call state by switching the telephone network and the internet line speech path.

13. A method for performing a conference call between an Internet call and a telephone network call in a webphone system, comprising the steps of:
receiving a conference call input;
checking whether there exists a held call in response to the conference call input;
adding a speech channel and forming a speech path between subscribers, when there exists a held call; and
performing a conference call when the speech path is formed.

14. The method of claim 13, further comprising the steps of:
checking whether to add a new incoming call to the conference call in a conference call state;
adding the incoming call to the conference call, when determining to add the incoming call to the conference call;
when determining not to add the incoming call to the conference call, checking whether the new incoming call is in an active state, and holding or disconnecting the incoming call when the new incoming call is not in the active state;
checking whether the conference call is ended when the new incoming call is not in an active state, and holding the conference call when the conference call is not ended; and
releasing the speech channel over which the conference call is performed, when the conference call is ended.

15. The method of claim 14, further comprising the steps of:
receiving a hold key input in the conference call state; and
holding a current call in response to the hold key input to enter an idle state.

16. The method of claim 14, further comprising the steps of:
receiving a hold key input in the point-to-point call state;
checking whether there exists a held call in response to the hold key input, and holding a current call when there exists a held call; and
holding the current call, when there exists no held call, and holding or disconnecting the current call when there exists a held call, and then connecting the held call.

17. The method of claim 15, further comprising the steps of:
checking whether the current state is an idle state, receiving a hold key input when the current state is an idle state, and checking whether there exists a held call;
connecting the held call when there exists a held call; and
checking whether there exists a conference call, entering the point-to-point call state when there exists no conference call.

18. The method of claim 15, further comprising the steps of:
receiving a hold key input in the point-to-point call state;
checking whether there exists a held call in response to the hold key input, and holding a current call when there exists a held call;
holding the current call, when there exists no held call, and holding or disconnecting the current call when there exists a held call, and then connecting the held call; and
checking whether there exists a conference call, when the held call is connected, entering the point-to-point call state when there exists no conference call.

19. The method of claim 16, further comprising the steps of:
checking whether the current state is an idle state, receiving a hold key input when the current state is an idle state, and checking whether there exists a held call;
connecting the held call when there exists a held call; and
checking whether there exists a conference call, entering the point-to-point call state when there exists no conference call, and entering the conference call state when there exists a conference call.

20. The method of claim 13, further comprising the steps of:
receiving a hold key input in the point-to-point call state;
checking whether there exists a held call in response to the hold key input, and holding a current call when there exists a held call;
holding the current call, when there exists no held call, and holding or disconnecting the current call when there exists a held call, and then connecting the held call; and
checking whether there exists a conference call, when the held call is connected, entering the point-to-point call state when there exists no conference call, and entering the conference call state when there exists a conference call.
